(19) United States
(12) Patent Application Publication
(10) Pub. No.: US 2013/0018761 A1
(43) Pub. Date: Jan. 17, 2013

(54) Consumer-Level Food Source Information Tracking, Management, Reviewing, and Rating Method and System

(71) Applicant: Sung Bok Kwak, Milpitas, CA (US)

(72) Inventor: Sung Bok Kwak, Milpitas, CA (US)

(73) Assignee: HANA MICRON AMERICA INC., Milpitas, CA (US)

(21) Appl. No.: 13/183,177

(22) Filed: Jul. 14, 2011

(51) Int. Cl. G06Q 30/00

(52) U.S. Cl. 705/26.61

(57) ABSTRACT

A consumer-level food source information tracking and management system and a related method are disclosed. In one embodiment of the invention, a producer provides producer-specific and package-specific information for a particular food package to a consumer-level food source information tracking and management server. The consumer-level food source information tracking management server associates the producer-specific and package-specific information with a unique identifying code on a consumer-level food source information label attached to the particular food package. A retail consumer who uses a user interface device (e.g. smart phone, a computer) can operatively connect to the consumer-level food source information tracking and management server via a data network (e.g. Internet, LAN). The retail consumer may enter the unique identifying code on the consumer-level food source information label into the user interface device to access, review, and rate the producer-specific and package-specific information and share ratings and reviews with peers.

### BACKGROUND OF THE INVENTION

The present invention generally relates to information management methods and systems. More specifically, various embodiments of the present invention relates to one or more consumer-level food source information tracking and management methods and systems.

Modern consumers are increasingly becoming more concerned and interested in food source information for food packages in retail stores. As organic, pesticides-free, humane livestock treatment certifications (e.g. free range, cage free, and etc.), and other premium food product packages gain popularity in consumer's food purchase patterns, food producers and distribution channels are beginning to place more information on food labels attached to food packages.

For example, a food label on a beef package, which may have only included legally-required minimum disclosures (e.g. country of origin, expiration date, and etc.) several decades ago, is evolving into an elaborate juxtaposition of certification logos (e.g. “USDA Organic,” “American Grassfed,” “USDA Process Verified,” “Certified Humane,” “Animal Welfare Approved,” “Food Alliance Certification,” and etc.) and feed information such as access to pasture, antibiotic use in its feed, growth hormone use in its feed, and etc. Providing more detailed and elaborate food source information on a food label beyond legally-required disclosures is a trend occurring in a variety of food products, including animal produce (e.g. beef, poultry, pork, and etc.), agricultural produce (e.g. crops, fruits, vegetables, and etc.), seafood, and even processed foods (e.g. canned foods, artificially-processed snacks, and etc.). In numerous instances, providing more elaborate and detailed food source information associated with a particular food package may justify a higher margin or premium against the competition.

However, a food label can typically place only a limited amount of information due to space constraint. Therefore, sometimes it may not be very clear to a consumer what a certified logo or abbreviated information on the food label represents. Furthermore, the food label attached to a food package can only convey static information previously available at the time of printing of the label. The food label, once printed, is unable to reflect any dynamically-changing information associated with food sources.

Therefore, it may be desirable to devise a consumer-level food source information tracking and management system and a related method, which can provide detailed and dynamically-changing food source information to consumers for a particular food package. Furthermore, it may also be desirable to devise a system and a method for consumers to review and rate a food producer associated with the particular food package using the consumer-level food source information tracking and management system. In addition, it may also be desirable to provide a dynamically-changeable access control to the food producer to permit or restrict the consumers' access to certain food source information.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a consumer-level food source information tracking and management system is disclosed. This consumer-level food source information tracking and management system comprises: static and dynamic food source information directly or indirectly provided by a producer to the consumer-level food source information tracking and management server, wherein the dynamic food source information includes at least one of a real-time webcam view, GPS location info, and livestock RFID tag info of the producer's onsite asset; the consumer-level food source information tracking and management server with a CPU and a memory unit executing one or more programs to process and store the static and dynamic food source information periodically or continuously from the producer; a food package attached with a consumer-level food source information label containing a unique identifying code, wherein the unique identifying code is associated with the static and dynamic food source information separately stored in the consumer-level food source information tracking and management server; a consumer's user interface device configured to retrieve the static and dynamic food source information stored in the consumer-level food source information tracking and management server by entering, scanning, or using the unique identifying code in the consumer's user interface; and one or more data network transceivers operatively connecting the producer, the consumer-level food source information tracking and management server, and the consumer's user interface device for wireless and wired data communication.

In another embodiment of the invention, a method of tracking and managing consumer-level food source information is disclosed. This method comprises steps of: generating a consumer-level food source information label containing a unique identifying code; associating the consumer-level food source information label with a particular producer for direct or indirect data transmission from the particular producer to a consumer-level food source information tracking and management server, wherein the data transmission is direct if the particular producer is directly operatively connected to the consumer-level food source information tracking and management server, or indirect if the particular producer is using a separate information management system for entry of food source information; attaching the consumer-level food source information label to a food package originating from the particular producer; periodically or continuously transmitting producer-specific and package-specific information to the consumer-level food source information tracking and management server; and allowing a retail consumer to retrieve, review, and rate the producer-specific and package-specific information associated with the consumer-level food source information label.

### BRIEF DESCRIPTION OF DRAWINGS

FIG. 1 shows a block diagram for a consumer-level food source information tracking and management system and a related method in accordance with an embodiment of the invention.

FIG. 2 shows an example of a food package with a conventional food product label and a consumer-level food source information label in accordance with an embodiment of the invention.

FIG. 3 shows an example of a system diagram for a consumer-level food source information tracking and management system in accordance with an embodiment of the invention.

FIG. 4 shows an example of information which can be stored in an RFID tag or a location beacon (e.g. GPS) tag associated with a livestock animal or another asset of a producer, in accordance with an embodiment of the invention.

FIG. 5A shows an example of a circular RFID tag or a location beacon (e.g. GPS) tag associated with livestock or another asset of a producer, in accordance with an embodiment of the invention.

FIG. 5B shows an example of a rectangular RFID tag or a location beacon (e.g. GPS) tag associated with livestock or another asset of a producer, in accordance with an embodiment of the invention.

FIG. 6 shows an example of a consumer interface screen operatively connected to the consumer-level food source information tracking and management server, in accordance with an embodiment of the invention.

FIG. 7 shows a method of using a consumer-level food source information tracking and management system in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more consumer-level food source information tracking and management systems and methods. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

For the purpose of describing the invention, a term “livestock” is defined as farm animals raised for use and/or profit. The term “livestock” can include, but are not limited to, cattle, sheep, pigs, goats, horses, donkeys, mules, and poultry (e.g. chickens, ducks, turkeys, and geese).

In addition, for the purpose of describing the invention, a term “radio frequency identification,” or RFID, is defined as a wireless signal-based identification of a wirelessly-accessible tag, called an “RFID tag” using a wirelessly-accessible tag reader, called “RFID tag reader.” In general, an RFID tag contains information which may be written and/or read by the RFID tag reader, an RF antenna operatively connected to the RFID tag reader, or another tag information access device.

Furthermore, for the purpose of describing the invention, a term “location beacon” is defined as a location-tracking device attachable to a producer's asset Examples of the producer's asset include, but are not limited to, livestock, fish, plants, trees, fruits, food packages, buildings, and farmland. In general, the location beacon is configured to transmit location information periodically or in real time to a data processing unit such as a server and/or a base station. An example of a location beacon is a global positioning system (GPS) signal-based tag. In one embodiment of the invention, the location beacon is a discrete unit configured to transmit its current GPS coordinates to the server and/or the base station. In another embodiment of the invention, the location beacon is an integrated unit which combines the functions of an RFID tag and a GPS signal-based tag as a single tag.

Moreover, for the purpose of describing the invention, a term “producer,” or “food producer,” is defined as an entity capturing, producing, and/or providing agricultural goods, livestock, fishery, and other food-related products as an original or initial seller. Examples of producers include agricultural farms, livestock farms, dairy, and seafood farms. A “producer” is distinguished from brokering and distribution entities such as slaughterhouses, wholesalers, and retail stores, which are positioned in a distribution channel of food products.

In addition, for the purpose of describing the invention, a term “consumer-level food source information label” is defined as a printed label, an RFID product label tag, or another device containing a unique identifying code, wherein the unique identifying code is used to access producer-specific, package-specific, and/or other consumer-level food source information associated with a particular food package. The unique identifying code may be a bar code, an alphanumeric code, QR code, or another piece of identifying information. In a preferred embodiment of the invention, the consumer-level food source information label is attached to the particular food package, and a consumer is able to retrieve producer-specific, package-specific, and/or other consumer-level food source information if the unique identifying code is entered into a user interface device operatively connected to a consumer-level food source information tracking and management server. If a bar code or a QR code is present in the unique identifying code, it may be desirable to use a bar code scanner or an image scanner to enter the scanned barcode, the scanned QR code, or the scanned image information directly into a consumer's user interface device. The bar code scanner or the image scanner may be an integrated application to the consumer's user interface device, or a standalone unit. Similarly, alphanumeric or numeric codes may be scanned and recognized by an image scanner and an optical character recognition (OCR) program internal or external to the user interface device.

Furthermore, for the purpose of describing the invention, a term “server” is defined as a physical computer, another hardware device, a software module, or a combination thereof, wherein the “server” is dedicated to executing one or more computer programs. In general, a server is connected to other devices via one or more data transmission networks such as a local area network (LAN), a wide area network (WAN), and the Internet. In a preferred embodiment of the invention, a consumer-level food source information tracking and management “server” is configured to execute one or more computer programs in a CPU and a memory unit, wherein the one or more computer programs are configured to associate a consumer-level food source information label with a particular producer and a particular food package. In the preferred embodiment of the invention, the one or more computer programs are also configured to store static and dynamic food source information provided by the particular producer. Furthermore, in the preferred embodiment of the invention, the one or more computer programs executed on the consumer-level food source information tracking and management server also allow access of the static and dynamic food source information to a consumer who enters a unique identifying code (e.g. from the consumer-level food source information label) into a user interface device operatively connected to the consumer-level food source information tracking and management server.

One aspect of an embodiment of the present invention is providing a consumer-level food source information tracking and management system which provides and updates food source information from a food producer for a controlled network access to a consumer using a unique identifying code associated with a consumer-level food source information label.

Another aspect of an embodiment of the present invention is providing a method for operating a consumer-level food source information tracking and management system.

Yet another aspect of an embodiment of the present invention is providing consumers a user interface operable on a computer or a portable consumer device to rate and review a particular food package and/or a particular food producer associated with a consumer-level food source information label.

In addition, another aspect of an embodiment of the present invention is using an RFID tag or a location beacon to indicate a current location of a producer's asset (e.g. a grazing animal in a farm) to a consumer, depending on the producer's preference of disclosure of such information.

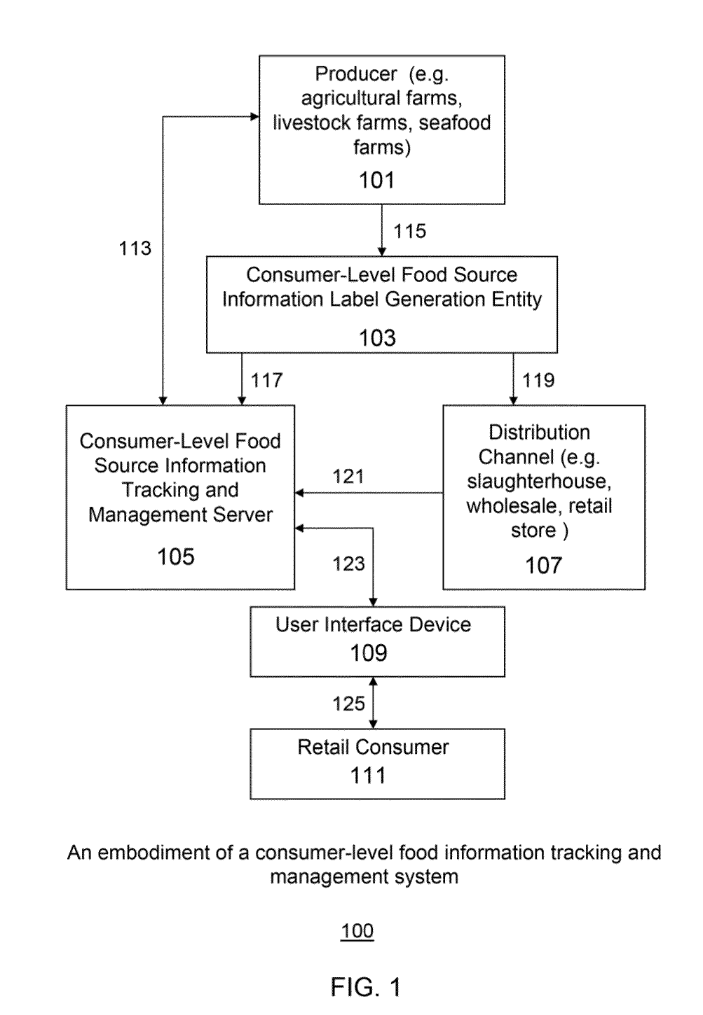

FIG. 1 shows a block diagram for a consumer-level food source information tracking and management system (100) and a related method in accordance with an embodiment of the invention. In a preferred embodiment of the invention, a producer (101) is an agricultural farm, a livestock farm, or a seafood farm which supplies a particular food package to a retail consumer (111) either directly or through a distribution channel (107).

One example of a distribution channel (107) includes a slaughterhouse or a food processing plant to clean and package the food, one or more wholesalers to distribute the food package over a greater distance, and a retail store which serves as a storefront for the retail consumer (111). Another example of a distribution channel (107) includes one or a combination of a food processing plant, a slaughterhouse, one or more wholesalers, a transportation network, and a retail store. In some instances, it may be desirable for the producer (101) to package the food in-house without using a separate food processing plant or a slaughterhouse, while utilizing other aspects of a distribution channel (107). Yet in some other instances, it may be desirable for the producer (101) to both package the food in-house and sell the packaged food directly to the retail consumer (111) without using much, if any, of the distribution channel (107) to maximize profits and provide lower prices to the retail consumer (111).

Continuing with FIG. 1, in a preferred embodiment of the invention, the consumer-level food information tracking and management system comprises a producer (101) providing raw or packaged food for sale, a consumer-level food source information label generation entity (103) which associates a unique identifying code per label with package-specific and/or producer-specific information. The package-specific and/or producer-specific information is typically provided (i.e. 115) by the producer (101) to the consumer-level food source information label-generation entity (103), which may be in-house or external. In addition, in some embodiments of the invention, at least part of the package-specific and/or producer-specific information may be linked to or provided by a third-party information service, such as livestock/agricultural tracing service provider or a livestock/agricultural information data service provider.

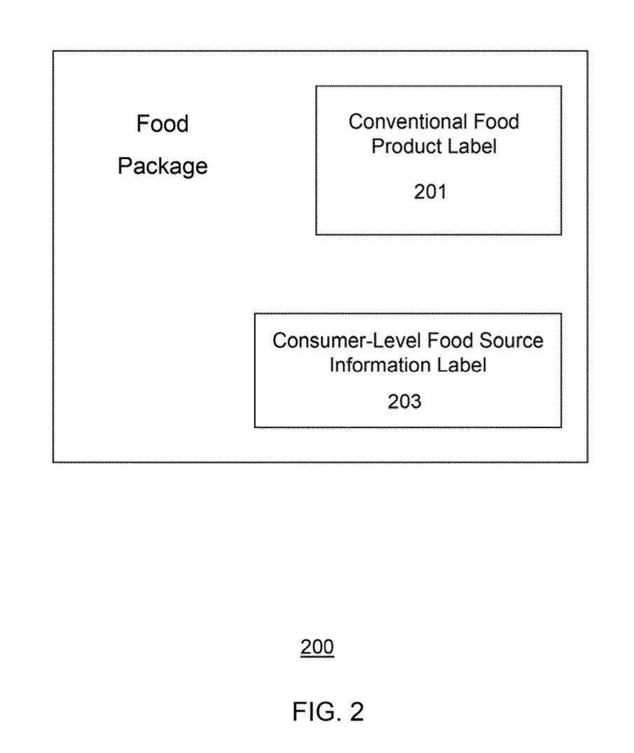

In one embodiment of the invention, a producer's in-house label generation may involve creating retail store-level food packages, with a consumer-level food source information label (e.g. 203 of FIG. 2) attached to each of the retail store-level food packages in the producer's in-house packaging operation. In this embodiment of the invention, the data association of the package-specific and/or producer-specific information with a particular consumer-level food source information label (e.g. 203 of FIG. 2) for the consumer-level food source information tracking and management server (105) is preferred to be completed during the in-house packaging processes.

Furthermore, in one embodiment of the invention, the producer (101) may directly enter (i.e. 113, or 115 and 117) food source information into the consumer-level food source information tracking and management server (105) using a producer's user interface (e.g. a producer's computer, a producer's smart phone, a producer's handheld device, and etc.), which is configured to transmit the food source information via a data network (e.g. the Internet, LAN, etc.). Alternatively, the producer (101) may utilize an internal or a separate information management system for data entry and updates related to the food source information, wherein the internal or the separate information management system is configured to communicate with the consumer-level food source information tracking and management server (105) for sharing of relevant food source information for review and rating by retail consumers.

In another embodiment of the invention, the consumer-level food source information label generation entity (103) is external, instead of being in-house within the producer (101). An external consumer-level food source information label generation entity may be a member of the distribution channel (107) such as a slaughterhouse or a wholesaler, which also creates retail store-level food packages and attaches consumer-level food source information labels (e.g. 203 of FIG. 2) to the retail store-level food packages. In this embodiment of the invention, the data association of the package-specific and/or producer-specific information with a particular consumer-level food source information label for the consumer-level food source information tracking and management server (105) is preferred to be completed during the external food packaging processes.

Furthermore, in one embodiment of the invention, a member of the distribution channel (107) may directly enter (i.e. 121) food source information into the consumer-level food source information tracking and management server (105) using a distribution channel member's user interface (e.g. a distribution channel member's computer, a distribution channel member's smart phone, a distribution channel member's handheld device, and etc.), which is configured to transmit the food source information via a data network (e.g. the Internet, LAN, etc.). Alternatively, a member of the distribution channel (107) may utilize an internal or a separate information management system for data entry and updates related to the food source information, wherein the internal or the separate information management system is configured to communicate with the consumer-level food source information tracking and management server (105) for sharing of relevant food source information for review and rating by retail consumers.

In a preferred embodiment of the invention, an in-house label-generation entity (103) within the producer (101), or an external label-generation entity (103) within the distribution channel (107) receives information (i.e. 115) from the producer (101) to associate a particular food package with a unique identifying code on a consumer-level food source information label (e.g. 203 of FIG. 2). The unique identifying code is typically a unique alphanumeric/numeric code, a bar code, and/or a QR code. If a bar code or a QR code is present in the unique identifying code, it may be desirable to use a bar code scanner or an image scanner to enter the scanned barcode information or the scanned QR code information directly into a consumer's user interface device. The bar code scanner or the image scanner may be an integrated application to the consumer's user interface device, or a standalone unit. Similarly, alphanumeric or numeric codes may be scanned and recognized by an image scanner and an optical character recognition (OCR) program internal or external to the user interface device.

In the preferred embodiment of the invention, this data association is processed and stored (i.e. 113 and 117 in case of in-house label-generation; 119, 121, and optionally 113 in case of an external label-generation) in the consumer-level food source information tracking and management server (105) for each food package attached with a consumer-level food source information label containing a unique identifying code.

Furthermore, in a preferred embodiment of the invention, the consumer-level food source information tracking and management server (105) contains a CPU and a memory unit which execute one or more computer programs to receive, process, and store package-specific and producer-specific information provided by the producer (101). The producer (101) may provide information to the consumer-level food source information tracking and management server (105) by using a user interface accessible on a producer's computer or another electronic device.

Moreover, in a preferred embodiment of the invention, the package-specific and producer-specific information provided by the producer (101) is associated with a particular unique identifying code from a consumer-level food source information label (e.g. 203 of FIG. 2) on a particular food package, and the associated information is stored inside a storage unit of the consumer-level food source information tracking and management server (105). In another embodiment of the invention, the data storage device storing the associated information per food package may be external, and this data storage device may be operatively connected to the consumer-level food source information tracking and management server (105).

Continuing with FIG. 1, the consumer-level food source information tracking and management server (105) is operatively connected (i.e. 113) to the producer (101), and a user interface device (109) is also operatively connected (i.e. 123) to the consumer-level food source information tracking and management server (105). In one embodiment of the invention, the user interface device (109) may be a smart phone operatively connected to the consumer-level food source information tracking and management server (105) via one or more data networks (e.g. LAN, WAN, Internet, and etc.). In another embodiment of the invention, the user interface device (109) may be a notebook or desktop computer operatively connected to the consumer-level food source information tracking and management server (105) via one or more data networks. Communication between the user interface device (109) and the consumer-level food source information tracking and management server (105) may involve a web browser in some embodiments, or another application in other embodiments.

Furthermore, in a preferred embodiment of the invention, one or more computer programs executable on the CPU and the memory unit of the consumer-level food source information tracking and management server (105) may allow controlled access to a retail consumer (111) who is operatively connected (i.e. 123, 125) to the consumer-level food source information tracking and management server (105) via a user interface device (109). In one embodiment of the invention, the level of access of the package-specific and producer-specific information to the retail consumer (111) is largely controlled by the producer (101). For example, if the producer (101) does not want to disclose vaccine records (e.g. 411 of FIG. 4) of a particular animal, but wants to reveal the age of the particular animal, the producer can adjust settings in the one or more computer programs executed on the CPU and the memory unit of the consumer-level food source information tracking and management server (105) to block viewing of the vaccine records and allow viewing of the age of the particular animal to the retail consumer (111).

In some embodiments of the invention, at least some portions of the producer-specific information provided by the producer (101) may be dynamic and include a real-time webcam view, GPS location info, livestock RFID tag info, and/or other information of a producer's onsite assets. Examples of a producer's onsite assets include, but are not limited to, livestock, fishery, plants, trees, farmland, farm buildings, and/or other properties associated with the producer, which may enhance a retail consumer's appreciation and understanding of the producer. Sharing such dynamic and visual information of a producer (101) with a retail consumer (111) may be particularly helpful for building a positive brand image, a high reputation, and a resilient consumer loyalty for a premium-grade, organic, and/or local producer.

FIG. 2 shows an example of a food package (200) with a conventional food product label (201) and a consumer-level food source information label (203) in accordance with an embodiment of the invention. The conventional food product label (201) may contain legally-required disclosures related to the food package (200) such as an expiration date, a country of origin, and some certification information. The conventional food product label (201) may also contain marketing information and conventional product identification information typically used in a distribution channel for the food package (200).

In a preferred embodiment of the invention, the consumer-level food source information label (203) is a printed label with a unique identifying code which is used as an identifier to associate the food package (200) to producer-specific and package-specific information stored in the consumer-level food source information tracking and management server (e.g. 105 of FIG. 1). This unique identifying code may be in form of an alphanumeric/numeric code, a bar code, a QR code, or a combination thereof. If a bar code or a QR code is present in the unique identifying code, it may be desirable to use a bar code scanner or an image scanner to enter the scanned barcode information or the scanned QR code information directly into a consumer's user interface device. The bar code scanner or the image scanner may be an integrated application to the consumer's user interface device, or a standalone unit. Similarly, alphanumeric or numeric codes may be scanned and recognized by an image scanner and an optical character recognition (OCR) program internal or external to the user interface device.

In the preferred embodiment of the invention, the consumer-level food source information label (203) is attached to the food package (200), and a consumer is able to retrieve producer-specific, package-specific, and/or other consumer-level food source information if the unique identifying code is entered into a user interface device operatively connected to a consumer-level food source information tracking and management server (e.g. 105 of FIG. 1).

Examples of producer-specific information include, but are not limited to, farm history and philosophy, size of the farm, and certifications or awards received by the farm. In some embodiments of the invention, at least some portions of the producer-specific information may be dynamic and include a real-time webcam view, GPS location info, livestock RFID tag info, and/or other information of a producer's onsite assets. Examples of a producer's onsite assets include, but are not limited to, livestock, fishery, plants, trees, farmland, farm buildings, and/or other properties associated with the producer, which may enhance a retail consumer's appreciation and understanding of the producer. Sharing such dynamic and visual information of a producer with a retail consumer may be particularly helpful for building a positive brand image, a high reputation, and a resilient consumer loyalty for a premium-grade, organic, and/or local producer.

Furthermore, examples of package-specific information include, but are not limited to, special qualities of the food package, vaccination history (in case of meat products), recommended recipes, and feed information (e.g. use of antibiotics, growth hormones, livestock feed sources, and etc.). In some embodiments of the invention, some portions of the package-specific information may also be dynamic.

In general, both producer-specific information and package-specific information are static and/or dynamic food source information provided by a producer. A portion of the food source information which does not change dynamically over a short period of time is considered “static” food source information. On the other hand, a portion of the food source information which typically receives frequent or periodic updates over the course of processing, distribution, and sale of a food package is considered “dynamic” food source information. Examples of the static food source information may include, but are not limited to, name of the producer, current location of the producer, and weight of the food package. Examples of the dynamic food source information may include, but are not limited to, real-time webcam view, GPS location info, livestock RFID tag info, and other information of the producer's dynamically-moving or changing onsite assets (e.g. livestock, fishery, and etc.).

In another embodiment of the invention, it may be desirable to incorporate or integrate the consumer-level food source information label (203) into the conventional food product label (201). Yet in another embodiment of the invention, the consumer-level food source information tracking and management server (e.g. 105 of FIG. 1) may use the conventional product identification information typically used within a distribution for the food package (200) to associate the producer-specific and package-specific information with the food package (200), instead of using a separate unique identifying code.

Furthermore, in one embodiment of the invention, the consumer-level food source information label (203) may be an RFID product label tag or another device containing a unique identifying code, instead of being merely a printed label with a unique identifying code as disclosed in the preferred embodiment. This unique identifying code may be a bar code, a QR code, an alphanumeric code, a combination thereof, or another piece of identifying information.

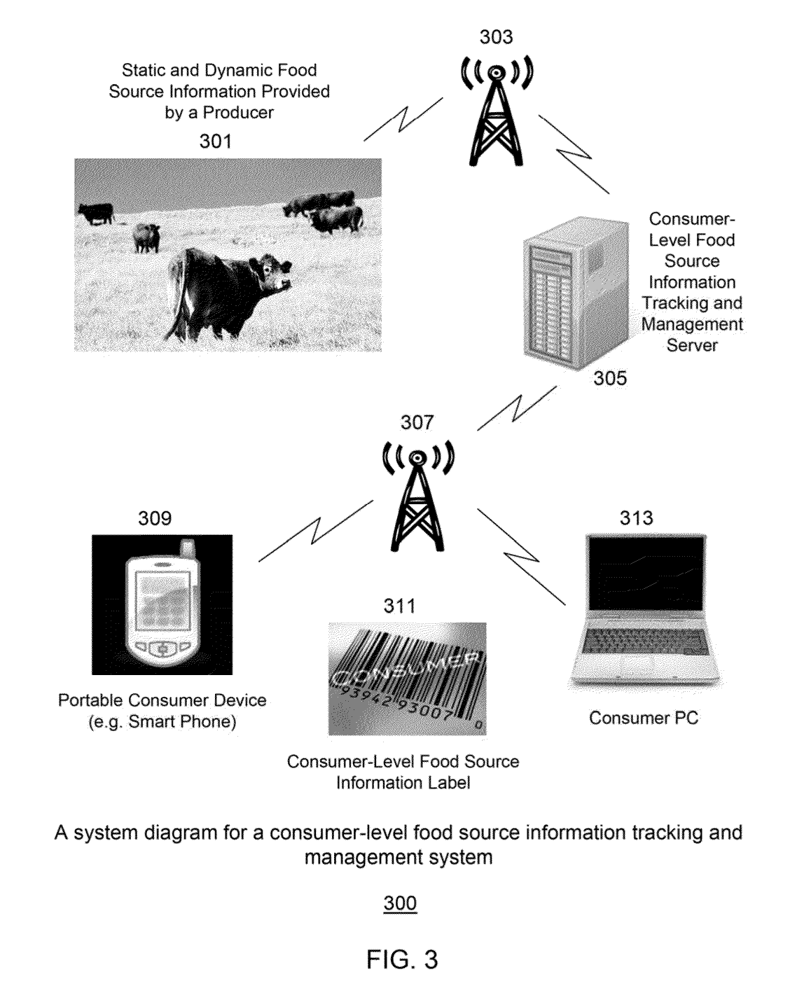

FIG. 3 shows an example of a system diagram for a consumer-level food source information tracking and management system (300) in accordance with an embodiment of the invention. In a preferred embodiment of the invention, the consumer-level food source information tracking and management system (300) comprises static and dynamic food source information (301) provided by a producer; a food package attached with a consumer-level food source information label containing a unique identifying code, wherein the unique identifying code is associated with the static and dynamic food source information separately stored in a consumer-level food source information tracking and management server; the consumer-level food source information tracking and management server (305) with a CPU and a memory unit executing one or more programs to process and store the static and dynamic food source information (301) from the producer; a consumer's user interface device (309, 313) configured to retrieve the static and dynamic food source information (301) associated with a unique identifying code on a consumer-level food source information label (311); and one or more data network transceivers (303, 307) which operatively connect the producer providing the static and dynamic food source information (301), the consumer-level food source information tracking and management server (305), and the consumer's user interface device (309, 313).

In one embodiment of the invention, the one or more data network transceivers (303, 307) are cellular network base stations, satellites, wired routers, wireless LAN routers, or any combination thereof, which support wireless and wired data communications. Examples of cellular networks include, but are not limited to, GSM, GSM-EDGE, CDMA, W-CDMA, and 4G LTE. In another embodiment of the invention, the one or more data network transceivers (303, 307) may be nearly or entirely based on wireless connections. Yet in another embodiment of the invention, the one or more data network transceivers (303, 307) may be nearly or entirely based on wired connections. The consumer-level food source information tracking and management system (300) may operate in a variety of data networks such as the Internet, LAN, satellite networks, cellular networks, dedicated intranets, or any combination thereof.

Continuing with FIG. 3, in a preferred embodiment of the invention, the producer providing the static and dynamic food source information (301) is an agricultural farm, a livestock farm, or a seafood farm which supplies a particular food package to a retail consumer. In some embodiments of the invention, a member of a distribution channel transporting and distributing the particular food package may also be involved in supplying, updating, or changing the static and dynamic food source information (301). Examples of members of a distribution channel includes a slaughterhouse, a food processing plant, a transportation company, a wholesaler, and a retail store.

In a preferred embodiment of the invention, the producer provides raw or packaged food for sale. A consumer-level food source information label generation entity, which may be external or in-house to the producer, associates a unique identifying code per label with package-specific and/or producer-specific information. The unique identifying code is typically a unique alphanumeric/numeric code, a QR code, and/or a bar code. This data association is then processed and stored in the consumer-level food source information tracking and management server (305).

In one embodiment of the invention, a producer's in-house label generation may involve creating retail store-level food packages, with a consumer-level food source information label (e.g. 311) with unique identifying code attached to each of the retail store-level food packages in the producer's in-house packaging operation. In this embodiment of the invention, the data association of the static and dynamic food source information (301) with a particular consumer-level food source information label (e.g. 311) is completed during the in-house packaging operation by transmitting relevant information to the consumer-level food source information tracking and management server (305).

In another embodiment of the invention, the consumer-level food source information label generation entity is external, instead of being in-house within the producer. An external consumer-level food source information label generation entity may be a slaughterhouse or a wholesaler, which also creates retail store-level food packages and attaches consumer-level food source information labels (e.g. 311) to the retail store-level food packages. In this embodiment of the invention, the data association of the static and dynamic food source information (301) with a particular consumer-level food source information label is completed during the external packaging operation by transmitting relevant information to the consumer-level food source information tracking and management server (305).

Furthermore, in a preferred embodiment of the invention, the consumer-level food source information tracking and management server (305) contains a CPU and a memory unit which execute one or more computer programs to receive, process, and store static and dynamic food source information (301) provided by the producer. The static and dynamic food source information (301) may be producer-specific and/or package-specific, as described for FIGS. 1-2. The producer may provide information to the consumer-level food source information tracking and management server (305) by using a user interface accessible on a producer's computer or another electronic device.

Moreover, in a preferred embodiment of the invention, the static and dynamic information (301) provided by the producer is associated with a particular unique identifying code from a consumer-level food source information label (e.g. 311) on a particular food package, and the associated information is stored inside a storage unit of the consumer-level food source information tracking and management server (305). In another embodiment of the invention, the data storage device storing the associated information per food package may be external, and this data storage device may be operatively connected to the consumer-level food source information tracking and management server (305).

Continuing with FIG. 3, in one embodiment of the invention, the consumer's user interface device (309, 313) may be a portable consumer device (309) (e.g. smart phone) operatively connected to the consumer-level food source information tracking and management server (305) via one or more data networks (e.g. LAN, WAN, Internet, and etc.). In another embodiment of the invention, the consumer's user interface device (309, 313) may be a notebook or desktop computer (313) operatively connected to the consumer-level food source information tracking and management server (305) via one or more data networks. Communication between the consumer's user interface device (309, 313) and the consumer-level food source information tracking and management server (305) may involve a web browser in some embodiments, or another application in other embodiments.

Furthermore, in a preferred embodiment of the invention, one or more computer programs executable on the CPU and the memory unit of the consumer-level food source information tracking and management server (305) may allow controlled access to a retail consumer who is operatively connected to the consumer-level food source information tracking and management server (305) via a consumer's user interface device (309, 313). In one embodiment of the invention, the level of access of the package-specific and producer-specific information to the retail consumer is largely controlled by the producer. For example, if the producer does not want to disclose vaccine records (e.g. 411 of FIG. 4) of a particular animal, but wants to reveal the age of the particular animal, the producer can adjust settings in the one or more computer programs executed on the CPU and the memory unit of the consumer-level food source information tracking and management server (305) to block viewing of the vaccine records and allow viewing of the age of the particular animal to the retail consumer.

In some embodiments of the invention, at least some portions of the static and dynamic food information (301) provided by the producer may be dynamic and include a real-time webcam view, GPS location info, livestock RFID tag info, and/or other information of a producer's onsite assets. Examples of a producer's onsite assets include, but are not limited to, livestock, fishery, plants, trees, farmland, farm buildings, and/or other properties associated with the producer, which may enhance a retail consumer's appreciation and understanding of the producer. Sharing such dynamic and visual information of the producer with a retail consumer with access to a consumer's user interface device (309, 313) may be particularly helpful for building a positive brand image, a high reputation, and a resilient consumer loyalty for a premium-grade, organic, and/or local producer.

FIG. 4 shows an example of information (400) stored in an RFID tag and/or a location beacon attachable to a producer's asset (e.g. animals, plants, crops, farm buildings), in accordance with an embodiment of the invention. In one embodiment of the invention involving the producer' asset as animals at a livestock farm, an RFID tag and/or a location beacon attachable to a particular animal stores a unique tag identification code (401) designed to identify the particular animal among a plurality of animals. For this embodiment of the invention involving the producer's asset as the animals, the unique tag identification code (401) for the particular animal is also typically associated with other pieces of information, such as a type/grade of each animal (403), date of birth (405), gender (407), owner (409), and vaccine records (411) for the particular animal. In addition, other information (413) deemed useful for keeping track for each animal may be stored to a non-volatile memory unit of the RFID tag and/or the location beacon attached to each animal.

Furthermore, in one or more embodiments of the invention, at least some information stored in an RFID tag and/or the location beacon may be transmitted to a consumer-level food source information tracking and management server (e.g. 305 of FIG. 3) periodically or upon request by a system manager or an authorized consumer. For example, in a preferred embodiment of the invention, current location information of a producer's asset located in its property (e.g. a cow grazing at a livestock farm) is transmitted to the consumer-level food information tracking and management server periodically or upon request. Therefore, if a consumer using a portable consumer device (e.g. 309 of FIG. 3) or a computer (e.g. 313 of FIG. 3) is operatively connected to the consumer-level food source information tracking and management server (e.g. 305 of FIG. 3) and is authorized to access the current location information of the producer's asset located in its property, the consumer can view the current location information of the producer's asset on a user interface screen. Depending on a particular implementation for an embodiment of the invention, the consumer may also be authorized to view other information stored in the RFID tag and/or the location beacon, such as type/grade of each animal (403), date of birth (405), gender (407), owner (409), and vaccine records (411).

In the preferred embodiment of the invention, the producer's asset (e.g. a cow grazing at a livestock farm) viewable on the user interface screen may be the same brand, grade, or product line related to a food package which the consumer is about to purchase or have already purchased. Providing a controlled level of information for a producer's asset to a consumer may improve brand and quality awareness of a particular producer. For example, a local livestock farm, a premium diary, or a premium organic farm may want to associate its onsite producer assets (e.g. a grazing cow, a free range diary cow, a free range chicken, and etc.) to its particular product package sold in retail stores to build a good brand image and a loyal customer base by using the consumer-level food source information tracking and management system as embodied by the present invention. It is conceivable that one or more embodiments of the present invention can be used for a particular producer to gain competitive advantage over its competition by being more “connected” with its consumer base via the consumer-level food source information tracking and management system disclosed in the present invention.

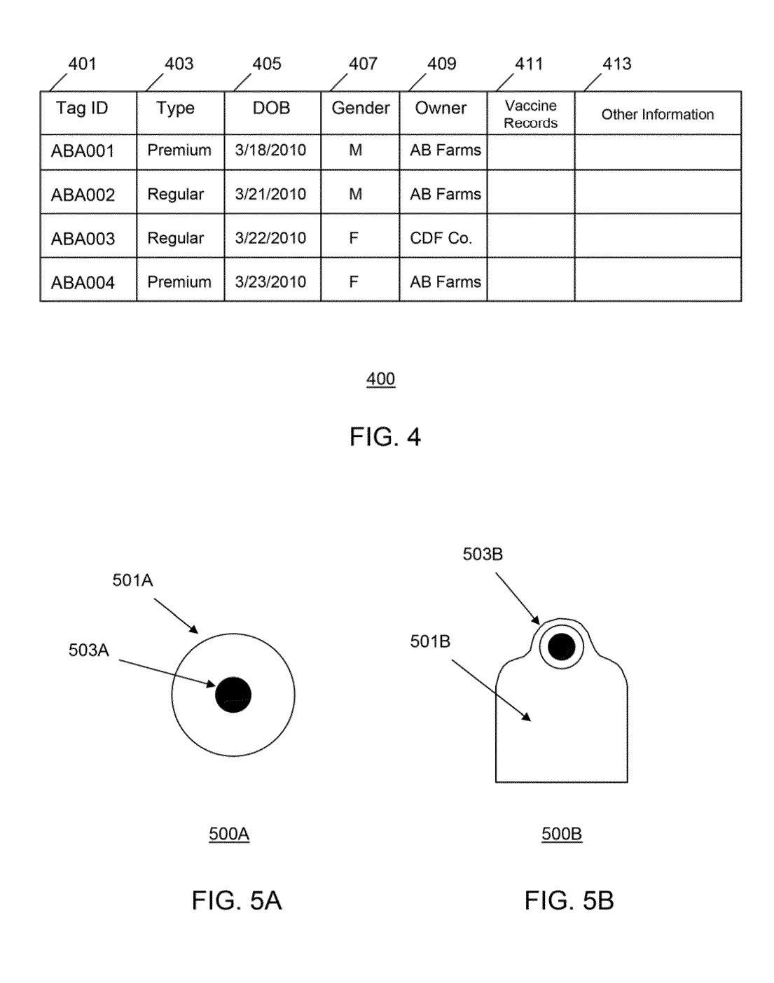

FIG. 5A shows an example of a circular RFID tag (500A) attachable to a producer's asset (e.g. an animal) in accordance with an embodiment of the invention. The circular RFID tag (500A) is typically used for a smaller animal such as a pig or a chicken. In a preferred embodiment of the invention, the circular RFID tag (500A) is a battery-less (i.e. without a battery) “passive” tag, which comprises a non-volatile memory unit and an RF antenna encapsulated by a weather-resistant covering (501A). In the preferred embodiment of the invention, the circular RFID tag (500A) has a diameter of 3.5 centimeters. The RF antenna in the circular RFID tag (500A) is configured to receive an electromagnetic signal from an RFID tag reader to energize the non-volatile memory unit inside the circular RFID tag (500A) to transmit information from or send information to the non-volatile memory unit. In another embodiment of the invention, the circular RFID tag (500A) may be a battery-powered “active” tag. Furthermore, the circular RFID tag (500A) may also combine the functions of a location beacon (e.g. a GPS beacon), which may be active or passive in its integrated tag design.

In the preferred embodiment of the invention, the circular RFID tag (500A) also has an attachment pin mechanism (503A) to enable a secure attachment of the circular RFID tag (500A) to a producer's asset, such as a body part of an animal. Furthermore, the weather-resistant covering (501A) is generally made of sturdy plastic, rubber, and/or other synthetic materials which are non-poisonous for use with edible livestock.

FIG. 5B shows an example of a rectangular RFID tag (500B) attachable to a producer's asset (e.g. an animal) in accordance with an embodiment of the invention. The rectangular RFID tag (500B) can be used in a variety of animals, but most notably, cattle. In a preferred embodiment of the invention, the rectangular RFID tag (500B) is a battery-less “passive” tag, which comprises a non-volatile memory unit and an RF antenna encapsulated by a weather-resistant covering (501B). The RF antenna in the rectangular RFID tag (500B) is configured to receive an electromagnetic signal from an RFID tag reader to energize the non-volatile memory unit inside the rectangular RFID tag (500B) to transmit information from or send information to the non-volatile memory unit. In another embodiment of the invention, the rectangular RFID tag (500B) may be a battery-powered “active” tag. Furthermore, the rectangular RFID tag (500B) may also combine the functions of a location beacon (e.g. a GPS beacon), which may be active or passive in its integrated tag design.

In the preferred embodiment of the invention, the rectangular RFID tag (500B) also has an attachment pin mechanism (503B) to enable a secure attachment of the rectangular RFID tag (500B) to a producer's asset, such as a body part of an animal. Furthermore, the weather-resistant covering (501B) is generally made of sturdy plastic, rubber, and/or other synthetic materials which are non-poisonous for use with edible livestock.

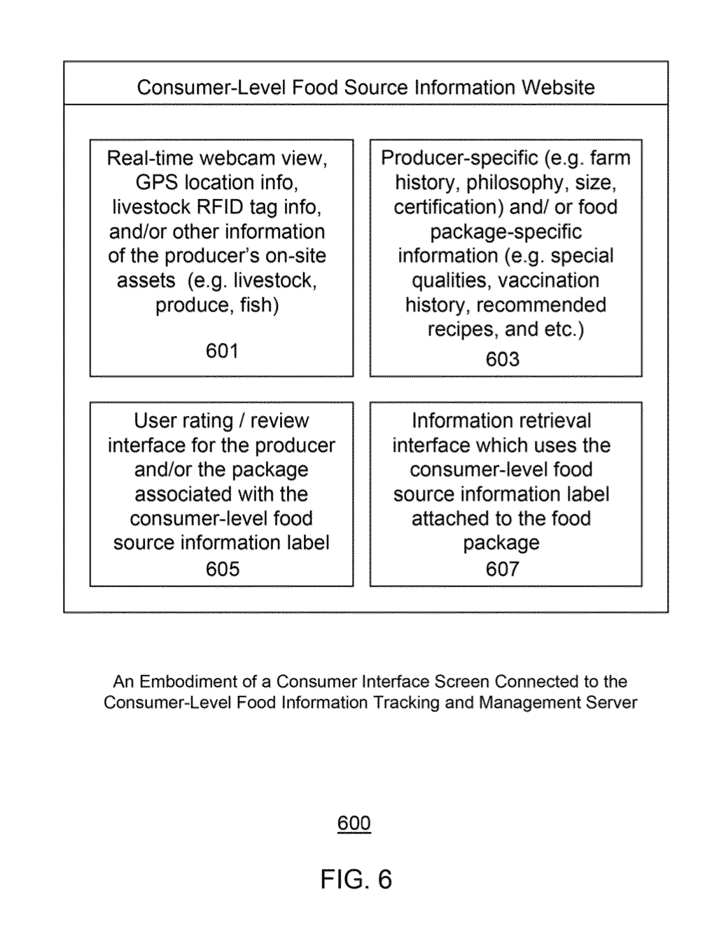

FIG. 6 shows an example of a consumer interface screen (600) operatively connected to a consumer-level food source information tracking and management server (e.g. 305 of FIG. 3), in accordance with an embodiment of the invention. In a preferred embodiment of the invention, the consumer interface screen (600) comprises a visual/graphical information window (601), a producer-specific/package-specific information window (603), a user rating/review interface (605) for reviewing and rating the producer and the package associated with the consumer-level food source information label, and an information retrieval interface (607) which uses a unique identifying code on the consumer-level food source information label to retrieve static and dynamic food source information.

In one embodiment of the invention, the consumer interface screen (600) may be a smart phone touch screen, or a touch screen of another portable consumer device. In another embodiment of the invention, the consumer interface screen (600) may be a PC screen. In the preferred embodiment of the invention, the visual/graphical information window (601) is configured to display a real-time webcam view of a producer's farm or property, livestock RFID tag information (e.g. items 401˜413 of FIG. 4), other visual information (e.g. photos, videos) of the producer's onsite assets (e.g. livestock, produce, fish), or a combination thereof. In the preferred embodiment of the invention, the producer's onsite assets (e.g. a cow grazing at a livestock farm) viewable on the user interface screen (600 or 601) may be the same brand, grade, or product line related to a food package which the consumer is about to purchase or have already purchased. The consumer-level food source information tracking and management server (e.g. 305 of FIG. 3) providing these visual/graphical information may be operatively connected to the consumer interface screen (600) via the Internet, or another data network.

Furthermore, in the preferred embodiment of the invention, the producer-specific/package-specific information window (603) is configured to display producer-specific information and/or package-specific information. Examples of producer-specific information include, but are not limited to, farm history and philosophy, size of the farm, and certifications or awards received by the farm. In some embodiments of the invention, at least some portions of the producer-specific information may be dynamic. Moreover, examples of package-specific information include, but are not limited to, special qualities of the food package, vaccination history (in case of meat products), recommended recipes, and feed information (e.g. use of antibiotics, growth hormones, livestock feed sources, and etc.). In some embodiments of the invention, some portions of the package-specific information may also be dynamic. In addition, in some embodiments of the invention, at least part of the package-specific and/or producer-specific information may be linked to or provided by a third-party information service, such as livestock/agricultural tracing service provider or a livestock/agricultural information data service provider.

In one embodiment of the invention, the real-time webcam view of a producer's farm or property, the livestock RFID tag information (e.g. items 401˜413 of FIG. 4), and other visual information (e.g. photos, videos) of the producer's onsite assets (e.g. livestock, produce, fish) are still considered producer-specific information, even if they are displayed on a separate visual/graphical information window (601). In another embodiment of the invention, these visual/graphical information may be incorporated into the producer-specific/package-specific information window (603).

Continuing with FIG. 6, in one embodiment of the invention, the user rating/review interface (605) is configured to show a retail consumer some of the peer consumer ratings for a particular producer, a particular food package, or a product. In addition, the user rating/review interface (605) may also be configured to enable the retail consumer to enter a personal review and rate a particular food package or a particular producer. In one embodiment of the invention, the retail consumer's entry of personal review and ratings can be transmitted and stored in the consumer-level food source information tracking and management server (e.g. 305 of FIG. 3). The personal review and ratings for a particular producer or a particular food package may be shared with peers in a social networks platform, or another portal website. In addition, the user rating/review interface (605) may be operated by a touch screen input method in one embodiment of the invention, or operated by a conventional display screen and physical keys or keyboards in another embodiment of the invention.

Moreover, in one embodiment of the invention, the information retrieval interface (607) enables the retail consumer's entry of the unique identifying code from the consumer-level food source information label to retrieve static and dynamic food source information associated with a particular food package. The data retrieval generally requires an operative connection between the consumer interface screen (600) and the consumer-level food source information tracking and management server (e.g. 305 of FIG. 3) over the Internet or another data network. The information retrieval interface (607) may be operated by a touch screen input method in one embodiment of the invention, or operated by a conventional display screen and physical keys or keyboards in another embodiment of the invention.

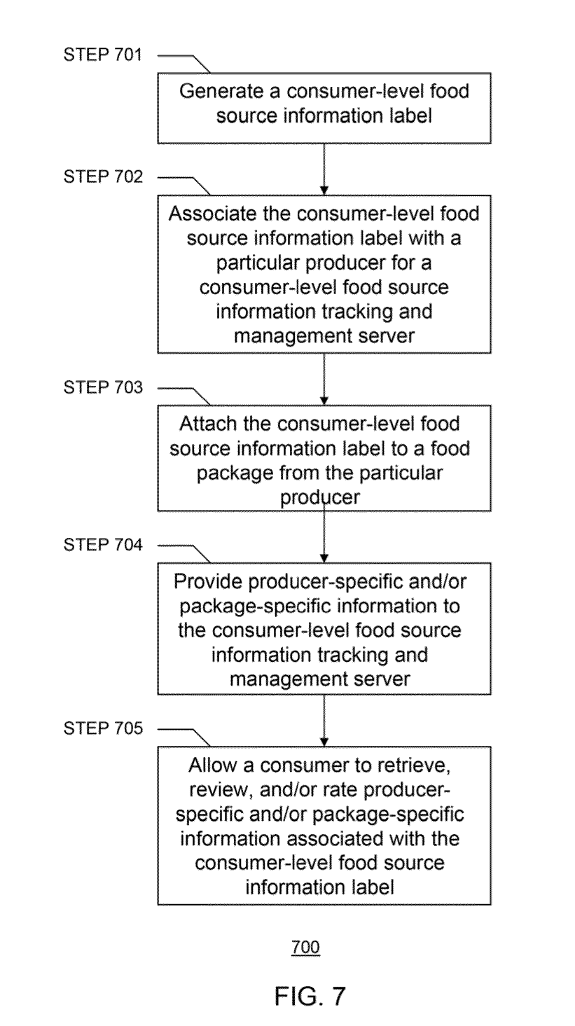

FIG. 7 shows a method (700) of using a consumer-level food source information tracking and management system in accordance with an embodiment of the invention. In a preferred embodiment of the invention, a consumer-level food source information label generation entity, which may be in-house or external to a producer, generates a consumer-level food source information label, as shown in STEP 701. Then, the consumer-level food source information label generation entity associates the consumer-level food source information label with a particular producer and a particular food package for processing and storage of data by a consumer-level food source information tracking and management server, as shown in STEP 702.

In the preferred embodiment of the invention, the consumer-level food source information label contains a unique identifying code which can be entered into a consumer's user interface device for retrieval of static and dynamic food source information stored in the consumer-level food source information tracking and management server. The unique identifying code may be a numeric code, an alphanumeric code, a bar code, and/or a QR code. Furthermore, the static and dynamic food source information typically includes producer-specific and package-specific information, as described for previous figures.

As shown in STEP 703, the consumer-level food source information label is attached to the particular food package by the producer or by a member of the distribution channel. Once the static and dynamic food source information (i.e. typically including the producer-specific and/or the package-specific information) are processed, stored, and periodically updated (i.e. in case of dynamic food source information) in the consumer-level food source information tracking and management server, as shown in STEP 704, the consumer-level food information tracking and management system can enable a retail consumer to retrieve, review, and/or rate the producer-specific and the package-specific information associated with the unique identifying code of the consumer-level food source information label, as shown in STEP 705.

Various embodiments of the present invention provide several key advantages to producers and retail consumers. By providing a controlled level of static and dynamic food source information to retail consumers via the consumer-level food source information tracking and management system, a producer can effectively communicate its brand value and operational quality with the retail consumers. For example, a local livestock farm, a premium diary, or a premium organic farm can readily associate and broadcast its onsite producer assets (e.g. a grazing cow, a free range diary cow, a free range chicken, and etc.) to its particular product package sold in retail stores by using the consumer-level food source information tracking and management system as embodied by the present invention. In many cases, the proactive communication of static and dynamic food source information to the retail consumers as disclosed by various embodiments of the present invention may contribute to building a good brand image and a loyal customer base for the producer and its product offerings. It is likely that one or more embodiments of the present invention can be used effectively for a particular producer to gain competitive advantage over its competition by being more “connected” with its retail consumer base via the consumer-level food source information tracking and management system.

Furthermore, by enabling the retail consumers to review and rate a particular food package and its producer based on both static and dynamic food source information available via the consumer-level food source information tracking and management system, a reputable producer may also gain additional brand awareness and popularity in social networking platforms or other online portals, which may allow sharing of ratings and reviews for the particular food package and its producer.

In addition, the retail consumers are likely to benefit from an increased transparency of food source information, which are dynamically observable over a consumer's user interface device such as a smart phone and a computer, when a unique identifying code on the food package is entered into the consumer's user interface device. It is likely that the retail consumers are able to make more informed decision on their food purchases due to the increased transparency of food source information.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A consumer-level food source information tracking and management system comprising:
static and dynamic food source information directly or indirectly provided by a producer to the consumer-level food source information tracking and management server, wherein the dynamic food source information includes at least one of a real-time webcam view, GPS location info, and livestock RFID tag info of the producer's onsite asset;
the consumer-level food source information tracking and management server with a CPU and a memory unit executing one or more programs to process and store the static and dynamic food source information periodically or continuously from the producer;
a food package attached with a consumer-level food source information label containing a unique identifying code, wherein the unique identifying code is associated with the static and dynamic food source information separately stored in the consumer-level food source information tracking and management server;
a consumer's user interface device configured to retrieve the static and dynamic food source information stored in the consumer-level food source information tracking and management server by entering, scanning, or using the unique identifying code in the consumer's user interface; and
one or more data network transceivers operatively connecting the producer, the consumer-level food source information tracking and management server, and the consumer's user interface device for wireless and wired data communication.

2. The consumer-level food source information tracking and management system of claim 1, wherein the static and dynamic food source information is package-specific and producer-specific.

3. The consumer-level food source information tracking and management system of claim 1, wherein the consumer's user interface device is a computer, a smart phone, or another portable consumer device.

4. The consumer-level food source information tracking and management system of claim 1, wherein the static food source information includes at least one of name of the producer, current location of the producer, and weight of the food package.

5. The consumer-level food source information tracking and management system of claim 1, wherein the unique identifying code is a numeric code, an alphanumeric code, a bar code, a QR code, or a combination thereof.

6. The consumer-level food source information tracking and management system of claim 1, wherein the wireless and wired data communication enabled by the one or more data network transceivers operate in at least one of the Internet, an intranet, and LAN.

7. The consumer-level food source information tracking and management system of claim 1, wherein the consumer's user interface device is further configured to process, transmit, and share a retail consumer's review and rating for the food package and the producer in a social networking platform or another online portal website.

8. The consumer-level food source information tracking and management system of claim 1, wherein the consumer-level food source information label containing the unique identifying code is a printed label, an RFID product label tag, or another device containing the unique identifying code.

9. The consumer-level food source information tracking and management system of claim 1, wherein the unique identifying code is scanned for entry by a bar code scanner, or an image scanner and an optical character recognition program internal or external to the consumer's user interface device.

10. The consumer-level food source information tracking and management system of claim 1, wherein each of the livestock RFID tag info of the producer's onsite asset includes at least one of a unique tag identification code, type and grade of each animal, date of birth, gender, owner, and vaccine records.

11. The consumer-level food source information tracking and management system of claim 1, wherein the GPS location info and the livestock RFID tag info are provided by an integrated tag combining functionality of an RFID tag and a location beacon.

12. The consumer-level food source information tracking and management system of claim 1, wherein the producer has a data access permission control for the consumer's user interface attempting to view the static and dynamic food source information.

13. A method of tracking and managing consumer-level food source information, the method comprising steps of:
generating a consumer-level food source information label containing a unique identifying code;
associating the consumer-level food source information label with a particular producer for direct or indirect data transmission from the particular producer to a consumer-level food source information tracking and management server, wherein the data transmission is direct if the particular producer is directly operatively connected to the consumer-level food source information tracking and management server, or indirect if the particular producer is using a separate information management system for entry of food source information;
attaching the consumer-level food source information label to a food package originating from the particular producer;
periodically or continuously transmitting producer-specific and package-specific information to the consumer-level food source information tracking and management server; and
allowing a retail consumer to retrieve, review, and rate the producer-specific and package-specific information associated with the consumer-level food source information label.

14. The method of claim 13, wherein the producer-specific and the package-specific information is at least partly dynamic and partly static.

15. The method of claim 13, wherein the unique identifying code is a numeric code, an alphanumeric code, a bar code, a QR code, or a combination thereof.

16. The method of claim 13, wherein the consumer-level food source information label containing the unique identifying code is a printed label, an RFID product label tag, or another device containing the unique identifying code.
